(19) United States
(12) Patent Application Publication
(10) Pub. No.: US 2012/0149560 A1
(43) Pub. Date: Jun. 14, 2012

(54) METHOD OF MANUFACTURING POROUS METAL OXIDE

(75) Inventors: Hyung-Kun LEE, Daejeon (KR); Nak Jin Choi, Daejeon (KR); Seungeon Moon, Daejeon (KR); Woo Seok Yang, Daejeon (KR)

(73) Assignee: Electronics and Telecommunications Research Institute, Daejeon (KR)

(21) Appl. No.: 13/284,758

(22) Filed: Oct. 28, 2011

(30) Foreign Application Priority Data
Dec. 8, 2010 (KR) 10-2010-0125105

(51) Int. Cl. B01J 37/02; B01J 23/44; B01J 23/42; B01J 23/50; B01J 23/755; B01J 23/72; B01J 23/34; B01J 23/06; B01J 23/745; B01J 23/14; B01J 23/08; B01J 21/06; B01J 23/30; B01J 23/22; B01J 23/75; B01J 35/10; B01J 37/08

(52) U.S. Cl. 502/305; 502/300; 502/339; 502/347; 502/337; 502/345; 502/324; 502/343; 502/338; 502/352; 502/355; 502/350; 502/349; 502/353; 502/325

(57) ABSTRACT

Provided is a method of manufacturing porous metal oxide, the method including: preparing a metal-organic framework (MOF) wherein an ion of a metal to be used as a catalyst is linked to an organic ligand; impregnating the MOF with a precursor solution of metal oxide to be manufactured; and thermally treating the metal oxide precursor solution-impregnated MOF to remove the organic ligand. The inventive method of manufacturing porous metal oxide involves the impregnation of a metal oxide precursor solution in a MOF wherein metal ions are uniformly linked to organic ligands and the thermal treatment (calcination) of the metal oxide precursor solution-impregnated MOF to remove the organic ligands.

### CROSS-REFERENCE TO RELATED PATENT APPLICATION

This application claims priority from Korean Patent Application No. 10-2010-0125105, filed on Dec. 8, 2010, in the Korean Intellectual Property Office, the disclosure of which is incorporated herein in its entirety by reference.

### BACKGROUND OF THE INVENTION

1. Field of the Invention

The present invention relates to a method of manufacturing porous metal oxides therein containing uniformly dispersed catalysts, and more particularly, to a method of manufacturing porous metal oxides therein containing uniformly dispersed catalysts using metal-organic frameworks (MOFs).

2. Description of the Related Art

Synthesis of various types of porous metal oxides and their applications as catalysts (e.g., gas sensors) have been reported. In particular, mesoporous metal oxides have a large surface area, uniform mesopores, and a highly crystalline frame structure, and thus, have received much interest for application as catalysts.

As a representative method for synthesis of such mesoporous metal oxides, a method of using porous silica as a template has been disclosed (Michael Tiemann, Chemistry A European Journal 2007, 13, 8376-8388, Korean Patent No. 10-0681766). A detailed method thereof is illustrated in FIG. 1. Referring to FIG. 1, a synthesis method of mesoporuos metal oxides includes: impregnating a metal oxide precursor in mesoporous silica used as a template; converting in situ the metal oxide precursor to desired metal oxide; and removing the silica template through treatment with hydrofluoric acid (HF) or a sodium hydroxide solution (NaOH). However, the removal of the silica template using HF or NaOH may cause the melting of the silica template and the metal oxide (in particular, ZnO).

In view of this problem, a method of manufacturing porous metal oxides using porous carbon as a template has been suggested (A. Dong et al, J. Am. Chem. Soc. 2003, 125, 4976-4978). A detailed method thereof is illustrated in FIG. 2.

Referring to FIG. 2, the manufacture of porous metal oxides includes two complicated replication procedures, i.e., the conversion of mesoporous silica to mesoporous carbon and the conversion of the mesoporous carbon to mesoporous metal oxide.

The above-described two methods are silent about uniform dispersion of catalysts in porous metal oxides to improve the sensitivity of gas sensors, etc.

General methods for dispersing metal catalysts or metal oxide catalysts in porous metal oxides include co-precipitation, deposition, impregnation, ion-exchange, etc. However, these methods have not yet provided uniform catalyst dispersion.

### SUMMARY OF THE INVENTION

The present invention provides a method of manufacturing porous metal oxides therein containing uniformly dispersed catalysts using metal-oxide frameworks (MOFs).

The present invention also provides a gas sensor with improved sensitivity including porous metal oxides therein containing uniformly dispersed catalysts, manufactured by the above-described method.

According to an aspect of the present invention, there is provided a method of manufacturing porous metal oxide, the method including: preparing a metal-organic framework (MOF) wherein an ion of a metal to be used as a catalyst is linked to an organic ligand; impregnating the MOF with a precursor solution of metal oxide to be manufactured; and thermally treating the metal oxide precursor solution-impregnated MOF to remove the organic ligand.

According to another aspect of the present invention, there is provided a gas sensor including porous metal oxide manufactured by the above-described method.

The inventive method of manufacturing porous metal oxide involves the impregnation of a metal oxide precursor solution in a MOF wherein metal ions are uniformly linked to organic ligands and the thermal treatment (calcination) of the metal oxide precursor solution-impregnated MOF to remove the organic ligands. Thus, it is possible to achieve a porous structure with a large surface area. Also, the metal ions are converted in situ into the corresponding metals or metal oxides which are uniformly dispersed as catalysts in the resultant porous metal oxide, and thus, the resultant porous metal oxide can be effectively used in gas sensors, reaction catalysts, etc. requiring high sensitivity.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional method of manufacturing mesoporous metal oxides using porous silica as a template.

FIG. 2 is a diagram illustrating a conventional method of manufacturing mesoporous metal oxides using porous carbon as a template.

FIG. 3 is a diagram schematically illustrating a method of manufacturing porous metal oxides therein containing uniformly dispersed metal or metal oxide catalysts according to an embodiment of the present invention.

FIG. 4 is a flowchart schematically illustrating a method of manufacturing porous metal oxides therein containing uniformly dispersed metal or metal oxide catalysts according to an embodiment of the present invention.

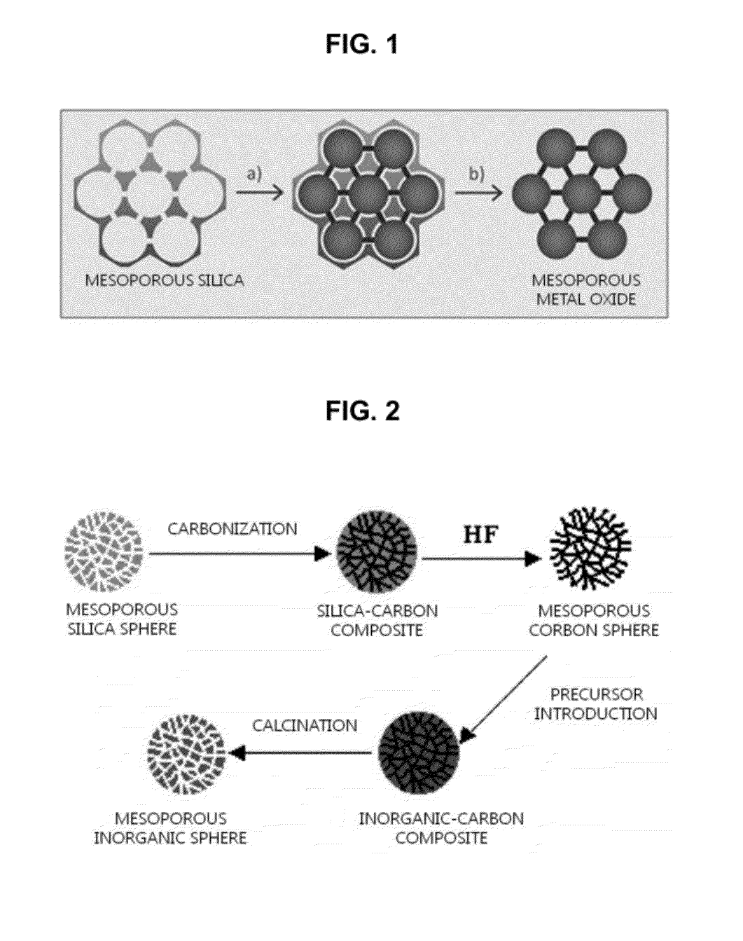

### DETAILED DESCRIPTION OF THE INVENTION

Hereinafter, the inventive method of manufacturing porous metal oxides therein containing uniformly dispersed catalysts will be described in more detail with reference to the accompanying drawings.

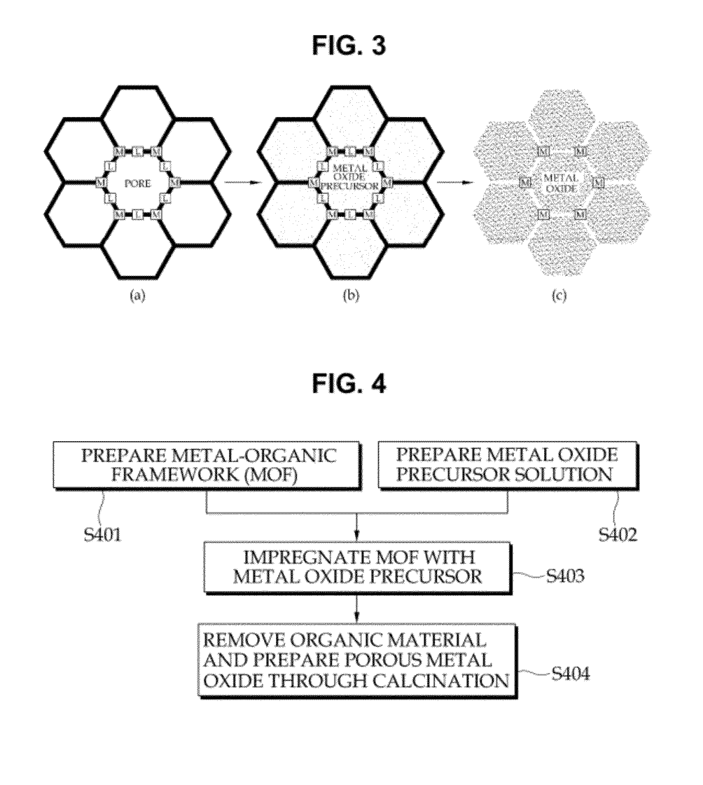

FIGS. 3 and 4 are respectively a diagram and a flowchart schematically illustrating a method of manufacturing porous metal oxides therein containing uniformly dispersed metal or metal oxide catalysts according to an embodiment of the present invention.

Referring to FIGS. 3 and 4, first, a metal-organic framework (hereinafter, simply referred to as “MOF”) wherein an ion of a metal (M) to be used as a catalyst is linked to an organic ligand (L) is prepared (see (a) of FIGS. 3 and S401 of FIG. 4).

MOFs are porous organic-inorganic compounds wherein transition metal ions are uniformly distributed through a linkage with organic ligands to form pores with a diameter of several nanometers (nm) or crystalline compounds with a frame structure containing both organic and inorganic materials and nano-sized pores. MOFs are generally called as porous coordination polymers (Angew. Chem. Intl. Ed., 43, 2334. 2004), porous metal-organic frameworks (Chem. Soc. Rev., 32, 276, 2003), porous organic-inorganic hybrid materials, etc. MOFs have been newly evolved recently due to the combination of molecular coordination technology and materials science. MOFs have a large surface area and nano-sized pores, and thus, have been actively studied in applications as adsorbants, gas storage media, sensors, membranes, functional thin films, catalysts, catalyst carriers, etc.

The MOF as used herein is not particularly limited, and may be a commercially available one containing ions of metals to be used as catalysts in porous metal oxides (BASF, Basolite Z1200) or may be prepared through the reaction of a mixture including a metal source as a donor of a metal to be used as a catalyst, an organic material used as a ligand, and a solvent.

In particular, O. M. Yaghi et al. at University of California in the United States, who are top experts in this field, have introduced methods of manufacturing MOFs using various metal ions (O. M. Yaghi et al. Chem. Soc. Rev. 2009, 38, 1257-1283).

The metal ion (M) constituting the MOF is an ion of a metal sought to be used as a catalyst and may be selected from transition metals such as palladium (Pd), platinum (Pt), silver (Ag), nickel (Ni), copper (Cu), manganese (Mn), zinc (Zn), iron (Fe), etc. Such a metal source may be a metal itself or any compound of a metal.

The organic ligand, which is another component of the MOF, is called as a linker and may be an organic material having a functional group capable of coordinating to the metal ion. The functional group capable of coordinating to the metal ion may be a carboxylic acid group, a carboxylate anion group, an amino group (—NH₂), an amide group (—CONH₂), a sulfonic acid group (—SO₃H), a sulfonylate anion group (—SO₃), a pyridine group, a pyrazine group, etc. Representative examples of the organic ligand include an organic acid selected from benzenedicarboxylic acid, naphthalenedicarboxylic acid, benzenetricarboxylic acid, naphthalenetricarboxylic acid, pyridinedicarboxylic acid, bipyridyldicarboxylic acid, formic acid, oxalic acid, malonic acid, succinic acid, glutaric acid, hexanedioic acid, heptanedioic acid, and cyclohexyldicarboxylic acid; an anion thereof; pyrazine; bipyridine; etc. Combination of two or more of these organic ligands may also be used.

In addition to the metal source and the organic ligand, an appropriate solvent is needed in the synthesis of the MOF. The solvent may be any one selected from water; alcohols such as methanol, ethanol and propanol; ketones such as acetone and methylethylketone; hydrocarbons such as hexane, heptanes and octane; ionic liquids; or a combination of two or more of them.

Next, the inventive method of manufacturing porous metal oxide includes preparing a metal oxide precursor solution (see S402 of FIG. 4) and impregnating the MOF with the metal oxide precursor solution (see S403 of FIG. 4 and (b) of FIG. 3).

Step S402 may be performed at the same time with, before or after step S401 (i.e., the preparation of the MOF).

The porous metal oxide sought to be manufactured may be selected from the group consisting of SnO₂, In₂O₃, TiO₂, WO₃, ZnO, ZrO₂, NiO, V₂O₅, MnO₂, CO₃O₄, Fe₂O₃, etc. Thus, a metal oxide precursor that can be included in the metal oxide precursor solution may be metal chloride, iodide, bromo-complex, amine-complex, nitro-complex, pyridine-complex, etc. for the formation of the above-described metal oxide. A solvent that can be used herein may be an organic solvent such as ethanol, methanol, pyridine, benzene, chloroform, methylenechloride, ethylacetate, acetonitrile, etc.

The term “impregnation” as used herein is the physical or chemical introduction of the metal oxide precursor solution into the pores of the MOF.

Next, the inventive method of manufacturing porous metal oxide includes drying and thermally treating the metal oxide precursor solution-impregnated MOF to remove the organic ligand (see (c) of FIG. 3 and S404 of FIG. 4).

The drying may be performed at 50 to 150° C. for 1 to 12 hours, and the thermal treatment (calcination) may be performed at 200 to 900° C. for 1 to 24 hours.

Through the thermal treatment, the organic ligands of the MOF are completely removed to form pores, and the metal oxide precursor is converted to the corresponding metal oxide. Also, the metal ions uniformly distributed through a linkage with the organic ligands in the MOF are converted in situ into the corresponding catalytic metals or metal oxides which are uniformly dispersed in the resultant porous metal oxide.

The resultant porous metal oxide may be SnO₂, In₂O₃, TiO₂, WO₃, ZnO, ZrO₂, NiO, V₂O₅, MnO₂, Co₃O₄, Fe₂O₃, etc., and the catalyst uniformly dispersed in the porous metal oxide may be a metal such as palladium (Pd), platinum (Pt), silver (Ag), nickel (Ni) or copper (Cu); metal oxide such as Ag₂O, Cu₂O, MnO₂, or NiO; etc. The metal used as the catalyst may be different from the metal used in the porous metal oxide.

There are no particular limitations on the amount of the catalyst in the porous metal oxide provided that the catalyst is used in a catalytically effective amount. Generally, the catalyst may be contained in the porous metal oxide in an amount of 0.1 to 10 wt % based on the total weight of the porous metal oxide. In order to satisfy with the above content range of the catalyst, steps S403 and S404 may be repeatedly performed while determining the ratio of the catalyst and the porous metal oxide after step S404.

The present invention also provides porous metal oxide therein including uniformly dispersed catalysts, manufactured by the above-described method.

The porous metal oxide has a large surface area, uniform porosity, and highly crystalline frame structure and includes uniformly dispersed catalysts therein, and thus, can be widely used in gas sensors, reaction catalysts, etc. requiring high sensitivity.

Hereinafter, the present invention will be described more specifically with reference to the following working examples. However, the following working examples are only for illustrative purposes and are not intended to limit the scope of the invention.

### EXAMPLE 1

### Manufacture of the Inventive Porous Metal Oxides (SnO₂)

<Step 1> Preparation of metal-organic frameworks (MOFs)

1.1 g of K₂PdCl₄ and 3.6 g of 2-hydroxypyrimidine hydrochloride were dissolved in water, and the reaction mixture was stirred at room temperature for one hour.

The reaction solution was washed with water to obtain microcrystalline powder. The microcrystalline powder was dispersed in water, and the resultant solution was adjusted to pH 6 in the presence of NaOH and stirred for five days to obtain palladium (Pd) ion-containing MOFs (Pd-MOFs) (897 mg, yield 90%). The resultant Pd-MOFs were determined to have a BET surface area of 10 to 2000 m²/g.

<Step 2> Preparation of porous metal oxides SnO therein including uniformly dispersed catalysts (Pd)

200 mg of Pd-MOFs prepared in Step 1 were dispersed in a solution of 10 g SnCl₂ in 1L anhydrous ethanol, and the reaction solution was stirred at room temperature for 24 hours.

Then, SnCl₂-impregnated MOFs were isolated through centrifugation, dried at 40° C. for one hour and calcined at 500° C. for five hours to remove the organic materials of the MOFs.

Through such a procedure, the metal oxide precursor SnCl₂ is converted to SnO₂, and the catalytic metal Pd of the MOFs is present in the metal or metal oxide form.

Element analysis was performed for the resultant porous SnO₂ to determine the ratio of the catalytic metal Pd and SnO₂. In order to satisfy with the desired ratio of the catalytic metal Pd and SnO₂, the impregnation of the metal oxide precursors in the MOFs, the drying and the calcination were repeatedly performed.

Finally, porous SnO₂ with 1 wt % of catalytic metal Pd was obtained.

### EXAMPLE 2

### Preparation of the Inventive Porous Metal Oxides (In₂O₃)

200 mg of Pd-MOFs prepared in Step 1 of Example 1 were dispersed in a solution of 10 g In(NO₃)₃ in 1L anhydrous ethanol, and the reaction solution was stirred at room temperature for 24 hours.

Then, In(NO₃)₃-impregnated MOFs were isolated through centrifugation, dried at 40° C. for one hour and calcined at 900° C. for two hours to remove the organic materials of the MOFs.

Through such a procedure, the metal oxide precursor In(NO₃)₃ is converted to In₂O₃, and the catalytic metal Pd of the MOFs is present in the metal or metal oxide form.

Element analysis was performed for the resultant porous In₂O₃ to determine the ratio of the catalytic metal Pd and In₂O₃. In order to satisfy with the desired ratio of the catalytic metal Pd and In₂O₃, the impregnation of the metal oxide precursors in the MOFs, the drying and the calcination were repeatedly performed.

Finally, porous In₂O₃ with 1 wt % of catalytic metal Pd was obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing porous metal oxide, the method comprising:
preparing a metal-organic framework (MOF) wherein an ion of a metal to be used as a catalyst is linked to an organic ligand;
impregnating the MOF with a precursor solution of metal oxide to be manufactured; and
thermally treating the metal oxide precursor solution-impregnated MOF to remove the organic ligand.

2. The method of claim 1, wherein in the preparation of the MOF, the metal ion is an ion of at least one metal selected from the group consisting of palladium (Pd), platinum (Pt), silver (Ag), nickel (Ni), copper (Cu), manganese (Mn), zinc (Zn) and iron (Fe).

3. The method of claim 1, wherein in the impregnation of the MOF with the metal oxide precursor solution, the metal oxide precursor is selected from the group consisting of chloride, iodide, bromo-complex, amine-complex, nitro-complex, and pyridine-complex of at least one metal selected from the group consisting of tin (Sn), indium (In), titanium (Ti), tungsten (W), zinc (Zn), zirconium (Zr), nickel (Ni), vanadium (V), manganese (Mn), cobalt (Co) and iron (Fe).

4. The method of claim 1, further comprising preparing the metal oxide precursor solution, before, after or simultaneously with the preparation of the MOF.

5. The method of claim 1, wherein the impregnation of the MOF with the metal oxide precursor solution and the removal of the organic ligand are repeated once or more.

6. The method of claim 1, wherein the catalyst is at least one metal selected from the group consisting of palladium (Pd), platinum (Pt), silver (Ag), nickel (Ni) and copper (Cu); or at least one metal oxide selected from the group consisting of Ag₂O, Cu₂O, MnO₂ and NiO.

7. The method of claim 1, wherein the porous metal oxide is at least one selected from the group consisting of SnO₂, In₂O₃, TiO₂, WO₃, ZnO, ZrO₂, NiO, V₂O₅, MnO₂, Co₃O₄ and Fe₂O₃.

8. The method of claim 1, wherein the catalyst is present in the porous metal oxide in an amount of 0.1 to 10 wt % based on the total weight of the porous metal oxide.

9. A gas sensor comprising porous metal oxide manufactured by the method of claim 1.
